(19) United States
(12) Patent Application Publication
(10) Pub. No.: US 2012/0265919 A1
(43) Pub. Date: Oct. 18, 2012

(54) INTERFACE DEVICE AND WIRING BOARD

(75) Inventors: Masayuki Jono, Osaka (JP); Tomoki Nakajima, Osaka (JP)

(73) Assignee: SHARP KABUSHIKI KAISHA, Osaka (JP)

(21) Appl. No.: 13/443,402

(22) Filed: Apr. 10, 2012

(30) Foreign Application Priority Data
Apr. 18, 2011 (JP) 2011-091696

(51) Int. Cl. G06F 13/42

(52) U.S. Cl. 710/316

(57) ABSTRACT

In the case of mounting two serial communication interfaces such as PCI-e and USB 3.0 with standards different from each other, it is allowed to flexibly address a design change and the like, and reduce a board area. An interface device is provided with a PCI-e PHY I/F, a USB 3.0 PHY I/F with equivalent specifications of a PIPE I/F to that of the PCI-e PHY I/F, and a system controller for controlling the PCI-e PHY I/F and the USB 3.0 PHY I/F. The interface device includes a PIPE I/F bridge in which the PCI-e PHY I/F and the USB 3.0 PHY I/F are provided, and the PIPE I/F bridge selectively switches connection of the PCI-e PHY I/F or the USB 3.0 PHY I/F with the system controller.

### CROSS-NOTING PARAGRAPH

This non-provisional application claims priority under 35 U.S.C. §119 (a) on Patent Application No. 2011-091696 filed in JAPAN on Apr. 18, 2011, the entire contents of which are hereby incorporated herein by reference.

### FIELD OF THE INVENTION

The present invention relates to an interface device and a wiring board, and more particularly, to an interface device of PCI-Express, USB 3.0 and the like allowing high-speed serial transfer, and a wiring board having the device mounted thereon.

### BACKGROUND OF THE INVENTION

Recently, in a field of an information processing apparatus including a personal computer (PC), an interface device employing a high-speed serial transmission system has been commercialized such as PCI-Express (Peripheral Component Interconnect Express, hereinafter, referred to as PCI-e) and USB (Universal Serial Bus) 3.0. This PCI-e employs not a conventional parallel transmission system but a serial transmission system, in which one serial communication wire of the PCI-e is referred to as a lane, and uses a plurality of lanes as appropriate to seek to increase the speed. In PCI-e Gen2, data transfer speed of 5G bps at a maximum has been realized.

FIG. 3 is a block diagram showing a configuration of a conventional interface device equipped with a PCI-e interface. In the diagram, 101 denotes a system controller, 102 denotes a PIPE (PHY Interface for the PCI Express Architecture) interface bridge (hereinafter, referred to as PIPE I/F bridge), and 105 denotes a PIPE interface (hereinafter, referred to as PIPE I/F). Here, the PIPE I/F is a standard I/F for enabling high-speed parallel bus communication, and connecting between a PHY (PHYsical layer) chip equipped with a PCS (Physical Coding Sublayer) function and a FPGA or an ASIC equipped with a MAC (Media Access Control Layer) function.

A PIPE I/F bridge 102 is provided with a PIPE-PHY bridge 103 and a PCI-e PHY I/F 104, and the PIPE-PHY bridge 103 is provided with a P-S (parallel-serial) conversion portion 103a, a FIFO (First In First Out) 103b and a bridge control portion 103c. The PCI-e PHY I/F 104 is a PCI-e interface (physical layer) for connecting a PCI-e-compliant device. A system controller 101 is provided with a PCI-e controller 101a, and this PCI-e controller 101a is connected to the PIPE-PHY bridge 103 via a PIPE I/F 105.

The PCI-e PHY I/F 104 is a serial communication interface and the PIPE I/F 105 is a parallel communication interface, thus performing serial-parallel conversion into each other by the P-S conversion portion 103a. A configuration of FIG. 3 is a configuration of a conventional common PIC-e interface having one lane, in which the PCI-e controller 101a is connected to the PCI-e PHY I/F 104 via the PIPE I/F 105. The PIPE as a standard I/F is used so that it is possible for a vendor who develops an endpoint device or a vendor who provides an IP (Intellectual Property) core in a MAC layer to perform development based on a common transfer protocol.

Further, the USB 3.0 was developed based on the technology of PCI-e Gen 2 described above, in which data transfer speed of 5 Gbps at a maximum is realized relative to 480 Mbps at a maximum of the USB 2.0 as a previous version thereof, seeking to significantly increasing the speed. In the USB 2.0, one differential transmission path is switched to be used on both an upstream direction and a downstream direction, however, in the USB 3.0, a dedicated differential transmission path is used on each of the upstream direction and the downstream direction to allow communication on both directions to be performed at the same time. This technology is a general method in high-speed serial communication of the PCI-e and the like.

Some common technologies have been employed in the USB 3.0 and the PCI-e, and for example, as a technology for increasing the speed, technologies of LVDS (Low Voltage Differential Signaling), CRU (Clock Recovery Unit) and the like have been employed. The LVDS is a differential signal transmission system using two transmission paths, and a system for converting a parallel signal into a low-voltage differential serial signal to be transmitted. In the USB 3.0, differential signal amplitude is defined to be at 0.8 V at a minimum and 1.2 V at a maximum as with the PCI-e. Additionally, regarding the CRU, in the USB 3.0, an embedded clock system is employed in which a clock is embedded in a data signal as with the PCI-e. All of such technologies are defined in accordance with standards.

The above-described USBs have been widely used as a universal interface for connecting a PC with a peripheral device, however, most of PCs have included the USB 2.0 as standard equipment so far, and also the USB 3.0 is expected to be widely used from now. Further, there is a PC including the PCI-e as standard equipment other than the USB, and for example, a technology is described in Japanese Laid-Open Patent Publication No. 2009-9564 for sharing a connector for the PCI-e and a connector for the USB 2.0 between each other. This makes it possible to share one connector between the PCI-e and the USB 2.0 having standards different from each other, thereby selectively connecting a PCI-e-compliant external device and a USB 2.0-compliant external device.

Here, for the above-described PCI-e and USB 3.0, strict restrictions are set also to specifications of data transfer timing of a PIPE interface in order to perform data transfer at high speed. Therefore, when these two serial communication interfaces are attempted to be mounted on an information processing apparatus such as a PC, it needs to provide two types of the PIPE interfaces in total, each of which is provided for the PCI-e and the USB 3.0, thus posing a problem that the number of terminals increases and both the two types have enlarged board areas for accepting restrictions set to specifications. FIG. 4 shows a configuration of a conventional interface device equipped with the PCI-e interface and the USB 3.0 interface.

As shown in FIG. 4, also for the USB 3.0, a USB 3.0 controller 101a′, a PIPE I/F bridge 102′, a PIPE-PHY bridge 103′, a P-S conversion portion 103a′, a FIFO 103b′, a bridge control portion 103c′, a USB 3.0 PHY I/F 104′ and a PIPE I/F 105′ are provided as with the PCI-e. In this manner, in the case of mounting both the PCI-e and the USB 3.0, each of which is provided with the PIPE interface, thus having increased the number of terminals and enlarged the board area.

Whereas, in accordance with specifications, characteristic impedance (also referred to as differential impedance) of the PCI-e is defined as 100″±10% including manufacturing errors, and the differential impedance of the USB 3.0 is also defined as 90″±7″ which is equivalent thereto. Moreover, also for electrical characteristics such as operating voltage, the equivalent electrical characteristics are defined in the PCI-e and the USB 3.0. Then, the PCI-e and the USB 3.0 have also the equivalent specifications of the PIPE interface for connecting a MAC layer and a PHY layer. Therefore, in the case of mounting the PCI-e and the USB 3.0, one PIPE interface is able to be shared between each other, and it is expected that this makes it possible to reduce the board area.

Further, in the case of assuming that a product is equipped with either one of the PCI-e and the USB 3.0, once wiring of the PIPE interface of the PCI-e is performed, it is naturally impossible to use the USB 3.0. Therefore, in the event of a design change afterwards to change to the USB 3.0, the wiring of the PIPE interface has to be changed. Even in this case, it is expected that the PIPE interface is shared between the PCI-e and the USB 3.0 to allow any one of the serial communication interfaces to be selected so that it is possible to flexibly address the design change afterwards.

However, since no technological thought has been proposed that the PIPE interface is shared between the PCI-e and the USE 3.0 in conventional technologies so far, it is impossible to solve the problem as described above. Further, the technology described in the Japanese Laid-Open Patent Publication No. 2009-9564 described above is only indicated that the connector of the PCI-e and the connector of the USB 2.0 are shared between each other, which does not refer to sharing of the PIPE interface between the PCI-e and the USB 3.0.

### SUMMARY OF THE INVENTION

An object of the present invention is to provide an interface device capable of flexibly addressing a design change and the like in the case of mounting two serial communication interfaces such as PCI-e and USB 3.0 with standards different from each other, and reducing a board area, and a wiring board having the device mounted thereon.

An object of the present invention is to provide an interface device comprising: a first serial communication interface; a second serial communication interface with equivalent specifications of a parallel communication interface to those of the first serial communication interface; and a controller for controlling the first serial communication interface and the second serial communication interface, wherein a bridge portion in which the first serial communication interface and the second serial communication interface are provided is included, and the bridge portion selectively switches connection of the first serial communication interface or the second serial communication interface with the controller via the one of the parallel communication interfaces.

Another object of the present invention is to provide the interface device, wherein the controller is provided with a first, controller for controlling the first serial communication interface, a second controller for controlling the second serial communication interface, and a connection control portion for connecting the first controller or the second controller to the parallel communication interface.

Another object of the present invention is to provide the interface device, wherein the connection control portion outputs a switching signal for switching connection of the first serial communication interface or the second serial communication interface with the parallel communication interface according to an instruction from the first controller or the second controller, and the bridge portion switches connection of the first serial communication interface or the second serial communication interface with the parallel communication interface based on the switching signal output from the connection control portion.

Another object of the present invention is to provide the interface device, wherein the bridge portion is provided with a conversion portion for converting a serial signal of the first serial communication interface or the second serial communication interface and a parallel signal of the parallel communication interface into each other.

Another object of the present invention is to provide a wiring board having the interface device mounted thereon.

### BRIEF DESCRIPTION OF THE DRAWINGS

FIG. 1 is a block diagram showing a configuration example of an information processing apparatus provided with an interface device according to the present invention;

FIG. 2 is a block diagram showing a configuration example of the interface device according to the present invention;

FIG. 3 is a block diagram showing a configuration of a conventional interface device equipped with a PCI-e interface; and

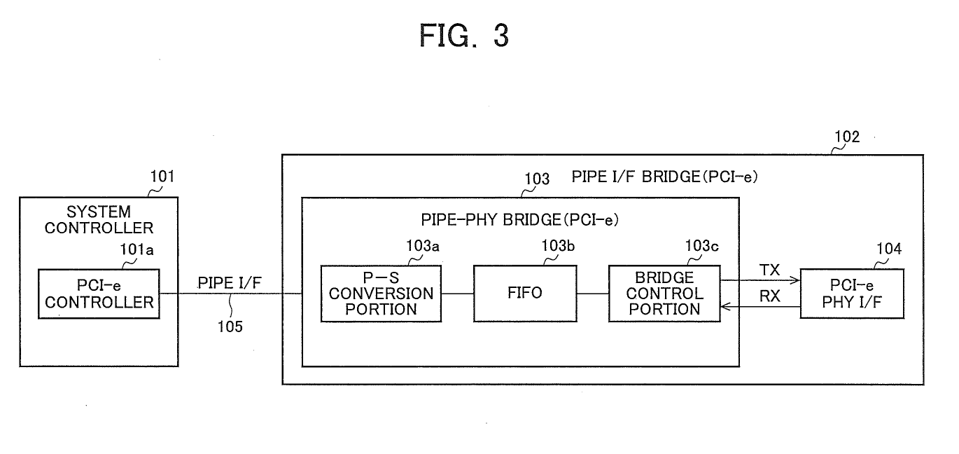

FIG. 4 is a block diagram showing a configuration of a conventional interface device equipped the PCI-e interface and a USB 3.0 interface.

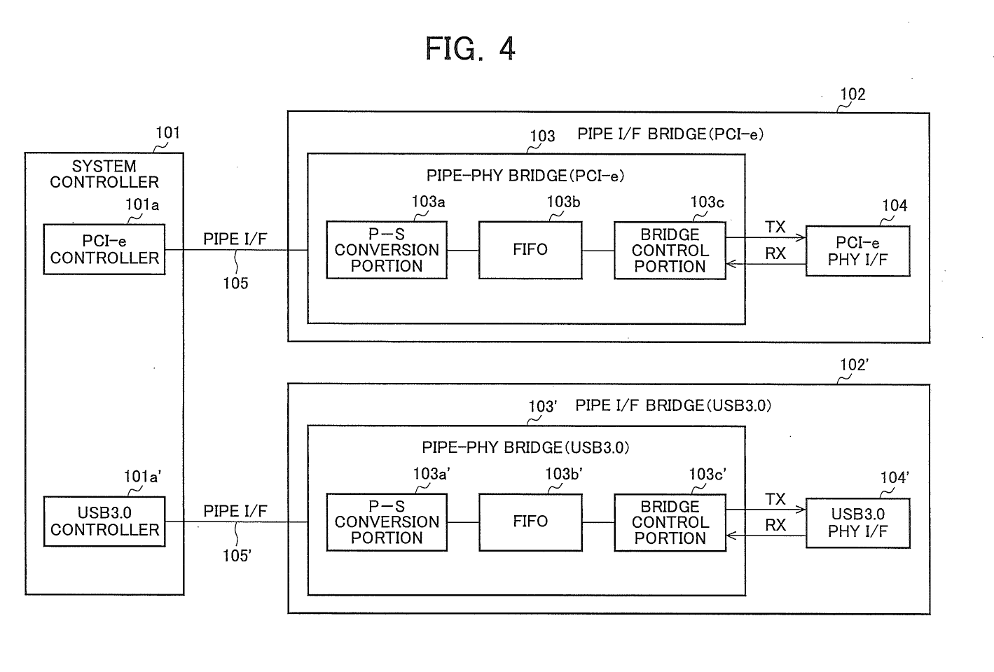

### PREFERRED EMBODIMENTS OF THE INVENTION

Hereinafter, description will be given for preferred embodiments according to an interface device and a wiring board having the device mounted thereon in the present invention with reference to accompanying drawings.

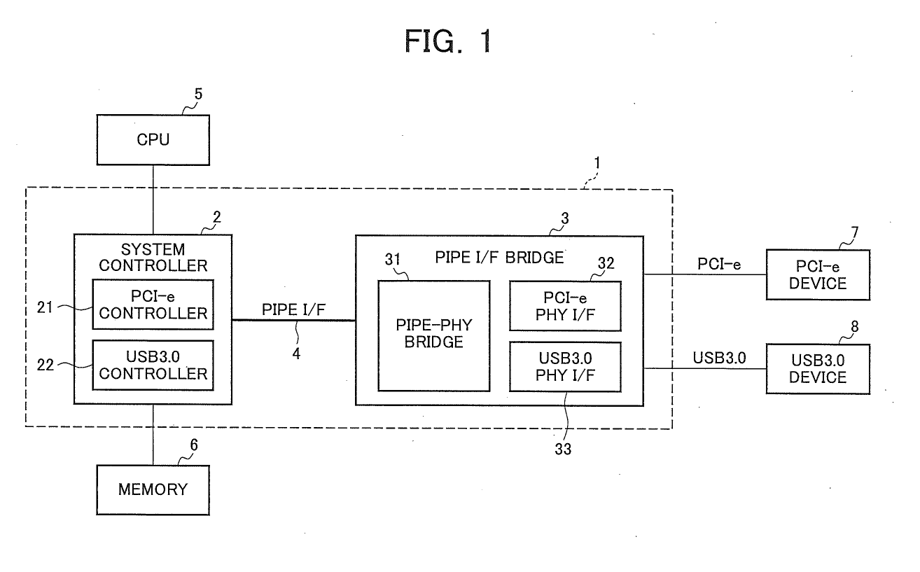

FIG. 1 is a block diagram showing a configuration example of an information processing apparatus provided with an interface device according to the present invention. This information processing apparatus is a common PC or the like comprised of an interface device 1, a CPU 5, a memory 6, a PCI-e device 7, and a USB 3.0 device 8. The interface device 1 is comprised of a system controller 2, a PIPE interface bridge (PIPE I/F bridge) 3, and a PIPE interface (PIPE I/F) 4.

The PIPE I/F bridge 3 is provided with a PIPE-PHY bridge 31, a PCI-e PHY interface (PCI-e PHY I/F) 32 and a USB 3.0 PHY interface (USB 3.0 PHY I/F) 33. The PCI-e device 7 is connected to the PCI-e PHY I/F 32, and the USB 3.0 device 8 is connected to the USB 3.0 PHY I/F 33. Note that, the PHY means a physical layer.

The system controller 2 corresponds to a controller of the present invention, and includes a PCI-e controller 21 corresponding to a first controller of the present invention for controlling the PCI-e PHY I/F 32 and a USB 3.0 controller 22 corresponding to a second controller of the present invention for controlling the USB 3.0 PHY I/F 33. To this system controller 2, the CPU 5 and the memory 6 are connected.

In the present embodiment, the PIPE I/F bridge 3 is connected to the system controller 2 via one PIPE I/F 4, and the PIPE I/F 4 corresponds to a parallel communication interface of the present invention to be shared between the PCI-e controller 21 and the USB 3.0 controller 22. In other words, these PCI-e controller 21 and USB 3.0 controller 22 are configured to use one PIPE I/F 4 by time division while performing arbitration (bus arbitration).

The PCI-e PHY I/F 32 corresponds to a first serial communication interface of the present invention. The USB 3.0 PHY I/F 33 corresponds to a second serial communication interface of the present invention, and has equivalent specifications of the PIPE interface to that of the PCI-e PHY I/F 32. Note that, in the case of having the equivalent specifications of the PIPE interface to that of the PCI-e PHY I/F 32, a serial communication I/F other than the USB 3.0 may be applied.

The PIPE I/F bridge 3 corresponds to a bridge portion of the present invention, and selectively switches connection of the PCI-e PHY I/F 32 or the USB 3.0 PHY I/F 33 with the system controller 2 via one PIPE I/F 4. That is, it is configured to share one PIPE I/F 4 therebetween by time division. Note that, in the present embodiment, the configuration in which two serial communication interfaces are included is indicated, however, it may be configured to include three or more serial communication interfaces.

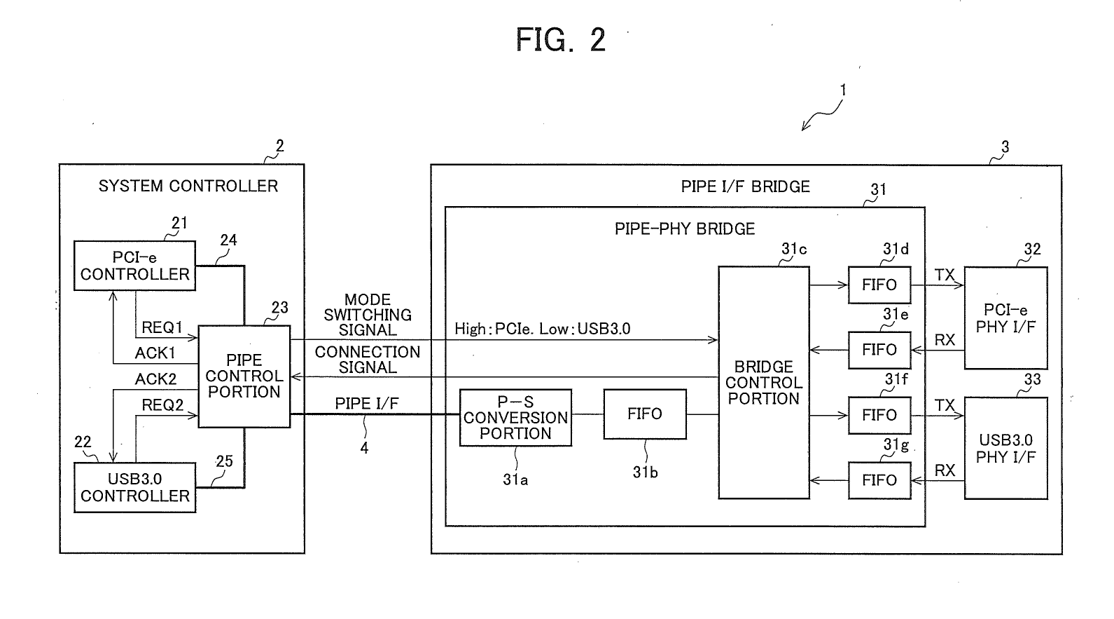

FIG. 2 is a block diagram showing a detailed configuration example of the interface device 1 shown in FIG. 1. The system controller 2 is provided with the PCI-e controller 21 for controlling the PCI-e PHY I/F 32, the USB 3.0 controller 22 for controlling the USB 3.0 PHY I/F 33, and a PIPE control portion 23 for connecting the PCI-e controller 21 or the USB 3.0 controller 22 to the PIPE I/F 4. The PIPE control portion 23 corresponds to a connection control portion of the present invention, and is connected to the PIPE I/F 4, while being connected to the PCI-e controller 21 via an internal PIPE I/F 24 and also to the USB 3.0 controller 22 via an internal PIPE I/F 25.

The PIPE control portion 23 selectively connects either one of the PCI-e controller 21 or the USB 3.0 controller 22 to the PIPE I/F 4. Specifically, based on a PIPE bus use request from the PCI-e controller 21 or the USB 3.0 controller 22, in order to perform bus arbitration, a bus use request signal REQ1 and a bus use permission signal ACK1 are sent or received to or from the PCI-e controller 21, and a bus use request signal REQ2 and a bus use permission signal ACK2 are sent or received to or from the USB 3.0 controller 22.

The PIPE I/F bridge 3 is provided with the PIPE-PHY bridge 31, and the PIPE-PHY bridge 31 is provided with a P-S conversion portion 31a for converting a serial signal of the PCI-e PHY I/F 32 or the USB 3.0 PHY I/F 33 and a parallel signal of the PIPE I/F 4 into each other; a FIFO 31b for buffering so as to be able to effectively transfer data between the P-S conversion portion 31a and a bridge control portion 31c; the bridge control portion 31c for performing bridge connection of the PCI-e PHY I/F 32 or the USB 3.0 PHY I/F 33 with the PIPE I/F 4; FIFOs 31d and 31e for buffering so as to be able to effectively transfer data between the bridge control portion 31c and the PCI-e PHY I/F 32; and FIFOs 31f and 31g for buffering so as to be able to effectively transfer data between the bridge control portion 31c and the USB 3.0 PHY I/F 33.

The bridge control portion 31c transmits a differential signal TX to the PCI-e PHY I/F 32, and receives a differential signal RX from the PCI-e PHY I/F 32. Similarly, the bridge control portion 31c transmits the differential signal TX to the USB 3.0 PHY I/F 33, and receives the differential signal RX from the USB 3.0 PHY I/F 33. These PCI-e PHY I/F 32 and USB 3.0 PHY I/F 33 have equivalent specifications of the PIPE interface, thus enabling sharing of one PIPE I/F 4 therebetween.

Since a so-called plug-and-play function is supported in the PCI-e and the USB 3.0, it is possible to automatically recognize when a corresponding device is connected thereto. In this example, the PCI-e PHY I/F 32 and the USB 3.0 PHY I/F 33 of the PIPE I/F bridge 3 are configured to have slots, and the bridge control portion 31c automatically recognizes when the slots are equipped with the PCI-e device 7 and the USB 3.0 device 8, respectively, then transmits a connection signal indicating that the devices are connected to the PIPE control portion 23 of the system controller 2. Same applies to a case where connection of the devices is cancelled, and the bridge control portion 31c automatically recognizes connection cancellation of the devices, and transmits a cancel signal indicating such information to the PIPE control portion 23 of the system controller 2.

As described above, the system controller 2 is able to recognize a connection status of whether or not a corresponding device is connected to each of the PCI-e PHY I/F 32 and the USB 3.0 PHY I/F 33.

Here, the PIPE control portion 23 outputs a switching signal (in the diagram, corresponding to a mode switching signal) for switching connection of the PCI-e PHY I/F 32 or the USB 3.0 PHY I/F 33 with the PIPE I/F 4 according to an instruction from the PCI-e controller 21 or the USB 3.0 controller 22. Then, the bridge control portion 31c switches connection of the PCI-e PHY I/F 32 or the USB 3.0 PHY I/F 33 with the PIPE I/F 4 based on the mode switching signal output from the PIPE control portion 23. The mode switching signal is a signal for recognizing whether a signal (data) transmitted/received via the PIPE I/F 4 is a signal of the PCI-e or a signal of the USB 3.0, and for example, is output as “High” in the case of the PCI-e and output as “Low” in the case of the USB 3.0 for the signal (data) transmitted/received via the PIPE I/F 4.

Specifically, when data is transmitted to the PCI-e device 7 or the USB 3.0 device 8, a device as a destination of the data (the PCI-e device 7 or the USB 3.0 device 8) is specified by operation of a user or the like. Further, when data is received from the PCI-e device 7 or the USB 3.0 device 8, similarly, a device as a source of data (the PCI-e device 7 or the USB 3.0 device 8) is specified by operation of a user or the like.

Then, a controller (PCI-e controller 21 or USB 3.0 controller 22) corresponding to the serial communication I/F of the specified device in the above transmits a bus use request signal REQ to the PIPE control portion 23, and in response, the PIPE control portion 23 returns a bus use permission signal ACK. Thereby, connection is established between the PCI-e controller 21 or the USB 3.0 controller 22 and the PIPE control portion 23. Then, the PIPE control portion 23 outputs to the bridge control portion 31c the mode switching signal for switching connection of the PCI-e PHY I/F 32 or the USB 3.0 PHY I/F 33 with the PIPE I/F 4 according to an instruction from the PCI-e controller 21 or the USB 3.0 controller 22.

For example, in the case of transmitting data to the PCI-e device 7, after the PCI-e controller 21 establishes connection with the PIPE control portion 23, according to an instruction from the PCI-e controller 21, the PIPE control portion 23 outputs to the bridge control portion 31c “High” as the mode switching signal for switching to the PCI-e. In the bridge control portion 31c, this mode switching signal “High” is received to switch connection to the PCI-e PHY I/F 32 corresponding to the received mode switching signal “High”, and a connection path between the PCI-e controller 21 and the PCI-e PHY I/F 32 is established. This makes it possible to transmit data to the PCI-e device 7 mounted on the PCI-e PHY I/F 32 via the PIPE I/F 4.

Further, in the case of transmitting data to the USB 3.0 device 8, after the USB 3.0 controller 22 establishes connection with the PIPE control portion 23, according to an instruction from the USB 3.0 controller 22, the PIPE control portion 23 outputs to the bridge control portion 31c “Low” as the mode switching signal for switching to the USB 3.0. In the bridge control portion 31c, this mode switching signal “Low” is received to switch connection to the USB 3.0 PHY I/F 33 corresponding to the received mode switching signal “Low”, and a connection path between the USB 3.0 controller 22 and the USB 3.0 PHY I/F 33 is established. This makes it possible to transmit data to the USB 3.0 device 8 mounted on the USB 3.0 PHY I/F 33 via the PIPE I/F 4.

Same basically applies to the case of receiving data from the PCI-e device 7 or the USB 3.0 device 8, and for example, in the case of receiving data from the PCI-e device 7, after the PCI-e controller 21 establishes connection with the PIPE control portion 23, according to an instruction from the PCI-e controller 21, the PIPE control portion 23 outputs to the bridge control portion 31c “High” as the mode switching signal for switching to the PCI-e. In the bridge control portion 31c, this mode switching signal “High” is received to switch connection to the PCI-e PHY I/F 32 corresponding to the received mode switching signal “High”, and a connection path between the PCI-e controller 21 and the PCI-e PHY I/F 32 is established. This makes it possible to receive data from the PCI-e device 7 mounted on the PCI-e PHY I/F 32 via the PIPE I/F 4.

Further, in the case of receiving data from the USB 3.0 device 8, after the USB 3.0 controller 22 establishes connection with the PIPE control portion 23, according to an instruction from the USB 3.0 controller 22, the PIPE control portion 23 outputs to the bridge control portion 31c “Low” as the mode switching signal for switching to the USB 3.0. In the bridge control portion 31c, this mode switching signal “Low” is received to switch connection to the USB 3.0 PHY I/F 33 corresponding to the received mode switching signal “Low”, and a connection path between the USB 3.0 controller 22 and the USB 3.0 PHY I/F 33 is established. This makes it possible to receive data from the USB 3.0 device 8 mounted on the USB 3.0 PHY I/F 33 via the PIPE I/F 4.

As described above, the system controller 2 is able to output the mode switching signal to the PIPE-PHY bridge 31 according to operation by a user to switch a path of the bridge control portion 31c. Since the system controller 2 is connected to the CPU 5 on the information processing apparatus side of FIG. 1, the CPU 5 detects when the user specifies a device from an operation portion (not illustrated), and controls the system controller 2. For example, when the user specifies the PCI-e device 7, the CPU 5 instructs the system controller 2 to output the mode switching signal corresponding to the PCI-e device 7.

As described above, description has been given for the embodiments of the interface device 1 and the information processing apparatus provided with the interface device 1, however, it is possible to mount the interface device 1 on a wiring board, and the present invention may be thus provided as a form of the wiring board having the interface device 1 mounted thereon. Specifically, it is possible to provide a form of the wiring board on which the system controller 2 and the PIPE I/F bridge 3 constituting the interface device 1 are mounted.

In this manner, according to the present invention, the PCI-e I/F and the USB 3.0 I/F have equivalent specifications of the PIPE interface, thus enabling sharing of one PIPE interface therebetween. This makes it possible to reduce the number of terminals of the system controller by nearly half, and reduce the board area. Further, a bridge is provided for selectively switching between a path of the PCI-e I/F and a path of the USB 3.0 I/F, thus making it possible to flexibly addressing a design change and the like.

As described above, according to the present invention, in the case of mounting two serial communication interfaces such as the PCI-e and the USB 3.0 with standards different from each other, the PCI-e and the USB 3.0 share the PIPE interface therebetween, while a bridge is provided for selectively switching between the PCI-e and the USB 3.0, so that it is possible to flexibly address a design change and the like, reduce the number of terminals and reduce a board area.

1. An interface device comprising:
a first serial communication interface;
a second serial communication interface with equivalent specifications of a parallel communication interface to those of the first serial communication interface; and
a controller for controlling the first serial communication interface and the second serial communication interface, wherein
a bridge portion in which the first serial communication interface and the second serial communication interface are provided is included, and the bridge portion selectively switches connection of the first serial communication interface or the second serial communication interface with the controller via the one of the parallel communication interfaces.

2. The interface device as defined in claim 1, wherein
the controller is provided with a first controller for controlling the first serial communication interface, a second controller for controlling the second serial communication interface, and a connection control portion for connecting the first controller or the second controller to the parallel communication interface.

3. The interface device as defined in claim 2, wherein
the connection control portion outputs a switching signal for switching connection of the first serial communication interface or the second serial communication interface with the parallel communication interface according to an instruction from the first controller or the second controller, and the bridge portion switches connection of the first serial communication interface or the second serial communication interface with the parallel communication interface based on the switching signal output from the connection control portion.

4. The interface device as defined in claim 1, wherein
the bridge portion is provided with a conversion portion for converting a serial signal of the first serial communication interface or the second serial communication interface and a parallel signal of the parallel communication interface into each other.

5. A wiring board having the interface device as defined in claim 1 mounted thereon.
